(19) United States
(12) Patent Application Publication
(10) Pub. No.: US 2021/0253895 A1
(43) Pub. Date: Aug. 19, 2021

(54) AQUEOUS SURFACE COATING SOLUTION COMPOSITION AND POLYESTER FILM STRUCTURE

(71) Applicant: NAN YA PLASTICS CORPORATION, Taipei (TW)

(72) Inventors: TE-CHAO LIAO, TAIPEI (TW); Wen-Cheng Yang, TAIPEI (TW); CHUN-CHE TSAO, TAIPEI (TW); WEN-JUI CHENG, TAIPEI (TW); CHIH-FU YEH, TAIPEI (TW)

(21) Appl. No.: 17/030,586

(22) Filed: Sep. 24, 2020

(30) Foreign Application Priority Data
Feb. 18, 2020 (TW) 109105110

(51) Int. Cl. C09D 167/06; C09D 133/10; C09D 175/14; C09D 5/34; C09D 7/40; C09D 7/62

(52) U.S. Cl. CPC C09D 167/06; C09D 133/10; C09D 7/62; C09D 5/34; C09D 7/67; C09D 175/14

(57) ABSTRACT

An aqueous surface coating solution composition and a polyester film structure are provided. The aqueous surface coating solution composition includes 5-20 wt % of a resin composition and 0.15-5 wt % of an inorganic particle dispersion liquid. The resin composition includes 0.01-10 wt % of a polyester resin, 2-19 wt % of an acrylate-grafted polyurethane resin, and 0.5-10 wt % of a cross-linking agent. The inorganic particle dispersion liquid includes a plurality of first inorganic filling particles and a plurality of second inorganic filling particles, and the first inorganic filling particles have a larger average particle diameter than the second inorganic filling particles.

### CROSS-REFERENCE TO RELATED PATENT APPLICATION

This application claims the benefit of priority to Taiwan Patent Application No. 109105110, filed on Feb. 18, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an aqueous surface coating solution composition, and more particularly to an aqueous surface coating solution composition for improving the applicability of a polyester film, and a polyester film structure using the aqueous surface coating solution composition.

### BACKGROUND OF THE DISCLOSURE

Optical films such as reflective films, diffusion films, and brightness enhancement films are widely used in the industry. For instance, optical films can be configured in a backlight module of a liquid crystal display to enhance a display effect. Biaxially stretched polyester film can be used to manufacture optical films because of its high transparency, high chemical resistance, and dimensional stability. However, the characteristics of the polyester film by itself are not enough to meet the application requirements of various optical films.

The characteristics of the polyester film are not only related to a crystallinity of a substrate (such as a PET substrate) and the type and content of additives in the substrate, but also affected by a coating on a surface. Filling particles are generally added to the coating to achieve the desired effect (such as optical effect, matte effect, smooth texture, and anti-sticking effect), and yet if the filling particles are aggregated, defects will occur on the coating, such as voids in the extended coating or an uneven surface of the coating, which are not conducive to the application of the polyester film. In addition, the polyester film is usually folded into a roll shape, and a certain length is then pulled out during use. However, in the process of pulling out the polyester film, the surface of the film can be easily stuck and be damaged. Further, the polyester film also needs to have good adhesion in use to avoid incomplete adhesion with a target and thereby fail to exert the desired effect.

### SUMMARY OF THE DISCLOSURE

In response to the above-referenced technical inadequacies, the present disclosure provides an aqueous surface coating solution composition, which can provide the characteristics required for polyester film applications, especially with respect to adhesion quality and releasability. The present disclosure also provides a polyester film structure using the aqueous surface coating solution composition.

In one aspect, the present disclosure provides an aqueous surface coating solution composition, which is usable for forming a surface coating on a polyester film. The aqueous surface coating solution composition includes 5-20 wt % of a resin composition and 0.15-5 wt % of an inorganic particle dispersion liquid. The resin composition includes 0.01-10 wt % of a polyester resin, 2-19 wt % of an acrylate-grafted polyurethane resin, and 0.5-10 wt % of a cross-linking agent. The inorganic particle dispersion liquid includes a plurality of first inorganic filling particles and a plurality of second inorganic filling particles, and the first inorganic filling particles have a larger average particle diameter than the second inorganic filling particles. The first inorganic filling particles and the second inorganic filling particles are uniformly dispersed in the surface coating, so that the surface coating has a surface roughness Ra between 0.004 μm and 0.025 μm.

In another aspect, the present disclosure provides a polyester film structure including a polyester film and a surface coating. The surface coating is formed on a surface of the polyester film, and the surface coating is formed by a composition having the aforementioned aqueous surface coating solution composition and has the surface roughness Ra between 0.004 μm and 0.025 μm.

One of the advantages of the present disclosure is that the aqueous surface coating solution composition can provide the characteristics required for polyester film applications, such as high transparency, low haze value, good adhesion, and smooth texture, by virtue of “the first inorganic filling particles have a larger average particle diameter than the second inorganic filling particles” and “the first inorganic filling particles and the second inorganic filling particles are uniformly dispersed in the surface coating, so that the surface coating has a surface roughness Ra between 0.004 μm and 0.025 μm”.

Furthermore, the surface coating formed by the surface coating solution composition of the present disclosure on the surface of the polyester film has stable and good releasability, so that the polyester film can be easily pulled out after being rolled and be used without any damage to the surface. In addition, the polyester film also has good adhesion, that is, has good adhesion quality with a target object (such as optical glue), and can adapt to complex three-dimensional shapes.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic view of a polyester film structure of the present disclosure.

FIG. 2 shows an enlarged view of a portion of FIG. 1.

FIG. 3 is a schematic view of a specific application of the polyester film structure of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

The use of a polyester film is extensive, and applications thereof include at least a diffusion film, a brightness enhancement film, an anti-reflection film, and a protective film Therefore, the present disclosure provides an aqueous surface coating solution composition to provide the characteristics required for polyester film applications, such as high transparency, low haze value, good adhesion, and smooth texture. The aqueous surface coating solution composition includes 5-20 wt % of a resin composition and 0.15-5 wt % of an inorganic particle dispersion liquid. It should be noted that the preferred range of the content of the resin composition is 5 wt % to 10 wt %, such as 6 wt %, 7 wt %, 8 wt %, or 9 wt %. The preferred range of the content of the inorganic particle dispersion liquid is 0.2 wt % to 2 wt %, such as 0.2 wt %, 0.45 wt %, 1 wt %, or 2 wt %.

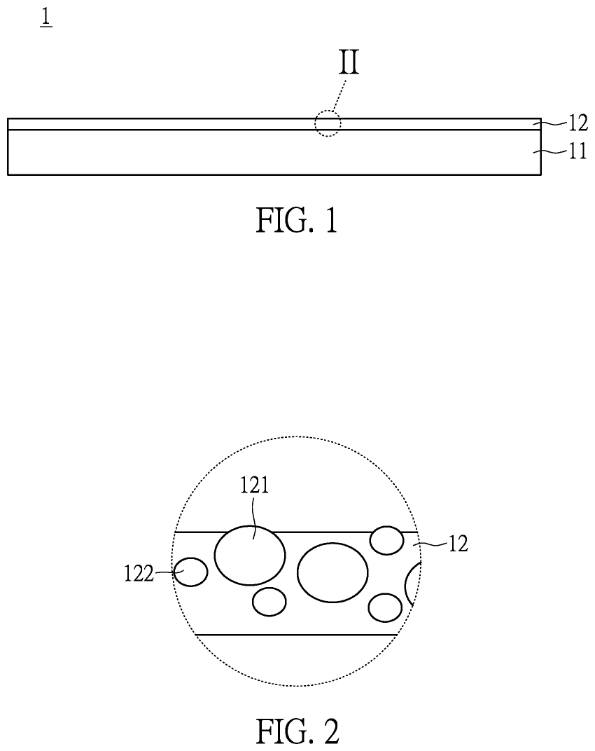

Referring to FIG. 1, the aqueous surface coating solution composition can be used in a form of coating liquid, that is, the aqueous surface coating solution composition can use water as a solvent, and the content of water can be 50 wt % to 85 wt %, but the present disclosure is not limited thereto. Further, the coating solution of the aqueous surface coating solution composition can be applied to a surface of a polyester film 11, and then be heat-treated at an appropriate temperature, so that the coating solution is dried and cured to form a surface coating 12. In addition, the polyester film 11 can be further processed according to particular implementations, for instance, the polyester film 11 is biaxially stretched to obtain required mechanical properties.

In this embodiment, the aqueous surface coating solution composition includes 0.01-10 wt % of a polyester resin, 2-19 wt % of an acrylate-grafted polyurethane resin, and 0.5-10 wt % of a cross-linking agent. A polyester resin of the resin composition is a modified waterborne polyurethane resin (having a solid content of 40%), and its molecular structure (such as a main chain and a side chain) has polyester segments and water-soluble groups of resins. The water-soluble groups includes SO₃Na groups and SO₃NH₄ groups. Further, the preferred range of the content of the polyester resin is 1 wt % to 6 wt %, such as 1 wt %, 2 wt %, 3 wt %, 4 wt %, 5 wt %, or 6 wt %. The polyester resin can be selected from water-soluble or water-dispersible polyester resin, which is polymerized by a specific acid component and a specific alcohol component. The acid component is selected from dicarboxylic acids containing sulfonic acid groups, and specifically includes sulfonic acid isophthalic acid, 5-sulfonic acid isophthalic acid, 2-sulfonic acid isophthalic acid, and 4-sulfonic acid isophthalic acid. The alcohol component specifically includes ethylene glycol, diethylene glycol, polyethylene glycol, propylene glycol, 1,3-propanediol, polypropylene glycol, 1,4-butanediol, 1,5-pentanediol, 1,6-hexanediol, cyclohexane-1,2-diol, 1,3-cyclohexanedimethanol, 1,4-cyclohexanedimethanol, and cyclohexane-1,4-diol.

An acrylate-grafted polyurethane resin of the resin composition is water-soluable. The main chain of the acrylate-grafted polyurethane resin modified by the acrylate-grafted polyurethane resin has groups and nonionic groups formed by polyisocyanate and polyol, and the side chain has an anionic group containing a sulfonic acid group, a nonionic group, and an acrylate group. It should be noted that the acrylate-grafted polyurethane resin shows improved mechanical strength, UV resistance, heat resistance, and water resistance compared to an unmodified polyurethane resin.

Further, the content of the acrylate-grafted polyurethane resin can be 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, or 18 wt %. The acrylate-grafted polyurethane resin can be prepared by the following steps.

(1) Preparation of prepolymer: After vacuum dehydration, 15-25 wt % of polyester (ether) polyol was added into the reactor equipped with a stirrer, a thermometer, and a condenser; after that, the reactor was heated with an oil bath, and when the temperature of the oil bath reached 70-80° C., 5-12 wt % of aliphatic diisocyanate was added to the reactor to proceed with the synthesis reaction.

(2) Dilution of prepolymer and chain extension: After the prepolymer has reacted for 2-3 hours, 10-30 wt % of acrylate monomer was added to dilute viscosity and the temperature was kept at 85-90° C. until an NCO theoretical equivalent ratio (NCO/OH) is 1.1-2.3, and then 1.5-3.0 wt % of sodium ethylenediaminoethanesulfonate (AAS) was added and the reaction was continued for 25-40 minutes.

(3) Dispersion of water: After cooling the polymer obtained in step (2) to room temperature, an appropriate amount of 35-55 wt % of deionized water under a 500 rpm high-speed shearing force was added, and then 0.1-0.5 wt % of metered ethylenediamine was added to proceed with a chain extension reaction for about 30 minutes so as to obtain a sulfonate-type polyurethane dispersion without solvent.

(4) Acrylic synthesis: 0.3-1.0 wt % of emulsifier sodium dodecyl sulfate (SLS) was added into the polyurethane dispersion obtained in step (3) and mixed so as to form an emulsion, which was then heated up to 50-70° C. 0.01-0.10 wt % of initiator ammonium persulfate aqueous solution (APS) was further added to proceed with acrylate polymerization. During polymerization, the temperature was continuously increased to 75-85° C. and maintained for 1-3 hours. After that, the temperature was reduced to 50-70° C., and then 0.01-0.08 wt % of a reducing agent was added to obtain the acrylate-grafted polyurethane resin.

The acrylate monomer added in step (2) includes 90-95 wt % of alkyl group-containing (meth)acrylate, 4-9 wt % of hydroxyl group-containing (meth)acrylate, and 1-5 wt % of carboxyl group-containing (meth)acrylate.

The alkyl group-containing (meth)acrylate can be selected at least one from mehyl (meth)acrylate, ethyl (meth)acrylate, propyl (meth)acrylate, n-butyl (meth)acrylate, isobutyl (meth)acrylate, 2-ethylhexyl (meth)acrylate, n-octyl (meth)acrylate, isooctyl (meth)acrylate, lauryl (meth)acrylate, stearyl (meth)acrylate, cyclohexyl (meth)acrylate, methoxyethyl (meth)acrylate, and ethoxymethyl (meth)acrylate. The hydroxyl group-containing (meth)acrylate can be selected at least one from 2-hydroxyethyl (meth)acrylate, 4-hydroxybutyl (meth)acrylate, chloro-2-hydroxypropyl acrylate, diethylene glycol monomethyl acrylate, and allyl alcohol. The carboxyl group-containing (meth)acrylate can be selected at least one from acrylic acid, methacrylic acid, itaconic acid, crotonic acid, maleic acid, fumaric acid, and maleic anhydride. The cross-linking agent of the resin composition is selected from at least one of a melamine resin, melamine modified resin, carbodiimide-based cross-linking agent, and oxazoline-based cross-linking agent. The content of the cross-linking agent can be 1 wt %, 2 wt %, 3 wt %, 4 wt %, 5 wt %, 6 wt %, 7 wt %, 8 wt %, or 9 wt %.

The treatment agent referred to in the present disclosure is selected from at least one composition containing a silicon-containing compound, a surfactant, and a polymer. The silicon-containing compound includes a silane compound or a polysilane compound, such as vinyl silane compound, methacryl oxysilane compound, propylene oxysilane compound, and epoxy silane compound.

The surfactant includes anionic surfactant and nonionic surfactant. Anionic surfactants include ammonium polyoxyethylene, nonyl phenyl ether sulfate, sodium polyoxyethylene nonyl phenyl ether sulfate, odium 2-ethylhexyl sulfate, sodium polyoxyethylene alkyl ether sulfate, ammonium polyoxyethylene lauryl ether sulfate, ammonium polyoxyethylene alkyl ether sulfate, and other anionic surfactants. Nonionic surfactants include polyethylene glycol alkyl ether, polyethylene glycol stearate, polyethylene glycol nonylphenol ether, polyethylene glycol octyl phenol ether, polyethylene glycol decyl ether, polyethylene glycol tridecyl ether, polyethylene glycol lauryl ether, and Uniqema Maxemul 5010, 5011, and other nonionic surfactants.

The inorganic particle dispersion liquid of the aqueous surface coating solution composition includes first inorganic filling particles and second inorganic filling particles with different particle sizes. The first inorganic filling particles and the second inorganic filling particles are each silicon oxide, titanium oxide, zirconium oxide, aluminum oxide, aluminum hydroxide, calcium carbonate, magnesium carbonate, or barium sulfate particles, and the material of the first inorganic filling particles can be the same as or different from the second inorganic filling particles. It should be noted that the average particle diameter of the first inorganic filling particles is between 100 nm and 180 nm, and the content of the first inorganic filling particles is 0.05 wt % to 0.3 wt %. The average particle diameter of the second inorganic filling particles is between 30 nm and 80 nm, and the content of the second inorganic filling particles, is 0.1 wt % to 0.5 wt %. Therefore, the polyester film can take into account different application requirements, such as providing an optical effect and an decorative effect, and protecting a screen of an electronic device.

The average particle diameter of the first inorganic filling particles is, for instance, 110 nm, 120 nm, 130 nm, 140 nm, 150 nm, 160 nm, or 170 nm. The content of the first inorganic filling particles is, for instance, 0.1 wt %, 0.15 wt %, 0.2 wt %, or 0.25 wt %. The average particle diameter of the second inorganic filling particles is, for instance, 35 nm, 40 nm, 45 nm, 50 nm, or 55 nm. The content of the second inorganic filling particles is, for instance, 0.15 wt %, 0.2 wt %, 0.25 wt %, 0.3 wt %, 0.35 wt %, 0.4 wt %, or 0.45 wt %.

Referring to FIG. 1, the surface coating 12 formed by the aqueous surface coating solution composition on the surface of the polyester film 11 has the first inorganic filling particles 121 and the second inorganic filling particles 122 uniformly dispersed therein and with a predetermined surface roughness Ra between 0.004 μm and 0.025 μm. Preferably, the surfaces of the first inorganic filling particles 121 and the second inorganic filling particles 122 are modified with an epoxy-functional silane coupling agent, so as to further improve the dispersibility in the surface coating 12. The epoxy-functional silane coupling agent can be selected from at least one of 2-(3 4-epoxycyclohexyl)ethyltrimethoxysilane, (3-glycidoxypropyl)trimethoxysilane, (3-glycidoxypropyl)methyldiethoxysilane, and 3-Glycidoxypropyl triethoxysilane. Therefore, the polyester film 11 has a stable and good releasability, so that the polyester film 11 can be easily pulled out after being rolled and be used without any damage to the surface. In addition, the polyester film 11 also has good adhesion, that is, has good adhesion quality with a target object (such as optical glue), and can adapt to complex three-dimensional shapes.

Functional additives of the aqueous surface coating solution composition can be selected from at least one of auxiliary agents, catalysts, and co-solvents, but is not limited thereto. The auxiliary agent helps to improve a wettability and flatness of the coating, the catalyst can control a reaction rate of a bridging of the surface coating, and the co-solvent can control an evaporation rate of a liquid component. The auxiliary agent can be silicon-containing, fluorine-containing, or silicon-fluorine-containing additive; the silicon-containing additive can specifically include BYK products such as BYK-307, BYK-325, BYK-331, BYK-380N, and BYK-381; specific examples of the fluorine-containing additive include 3M products FC-4430 and FC-4432, DuPont products Zonyl FSN-100, and Daikin products DSX; and the silicon-fluorine-containing additive can specifically include BYK products BYK346, BYK347 and BYK348. In addition, the catalyst can be inorganic substance, salt, organic substance, alkaline substance, or acidic substance. The co-solvent can be methanol, ethanol, n-propanol, isopropanol, isobutanol, or butyl cellulose. However, the present disclosure is not limited to the above-mentioned examples.

Referring to FIG. 1, the present disclosure further provides a polyester film structure 1 including a polyester film 11 and a surface coating 12, and the surface coating 12 is formed on a surface of the polyester film 11. Further, the polyester film 11 is formed of a polyester resin, such as a polyethylene terephthalate film (PET), a polyethylene naphthalate (PEN), and a polycarbonate (PC). The surface coating 12 is formed by the aqueous surface coating solution composition with the aforementioned composition, which has the first inorganic filling particles 121 and the second inorganic filling particles 122 with different particle sizes uniformly dispersed therein and with a predetermined surface roughness Ra between 0.004 μm and 0.025 μm.

In this embodiment, a thickness of the polyester film 11 is between 12 μm and 300 μm, and a thickness of the surface coating 12 is between 30 nm and 150 nm, but they are not limited thereto. The average particle diameter of the first inorganic filling particles 121 is between 100 nm and 180 nm, and the content of the first inorganic filling particles 121, based on a total weight of the surface coating 12, is 0.05 wt % to 1 wt %. The average particle diameter of the second inorganic filling particles 122 is between 30 nm and 80 nm, and the content of the second inorganic filling particles 122, based on the total weight of the surface coating 12, is 0.2 wt % to 3 wt %.

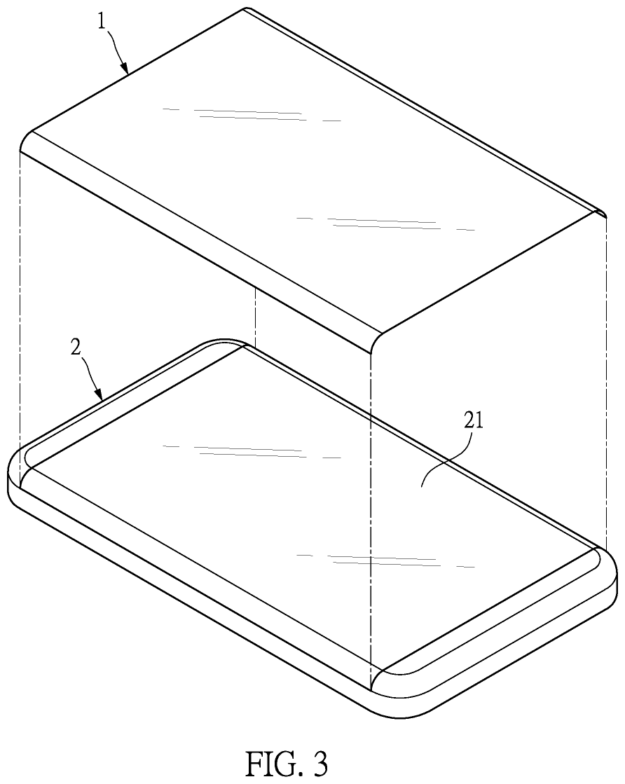

It should be noted that the polyester film structure 1 can adapt to complex three-dimensional shapes, for instance, as shown in FIG. 2, the polyester film structure 1 can be completely attached to a curved screen 21 of an electronic device 2 without any gaps in between. In addition, the surface coating 12 has high transparency and low haze value. A visible light transmittance measured according to a JIS K7705 test standard is at least 90%, and the haze value is less than 0.8%.

Visible light transmittance and haze value test: The visible light transmittance and the haze value of the surface coating 12 is tested by using a testing device (model TC-HIII DPK) of a Japanese merchant, Tokyo Denshoku, and according to the JIS K7705 test standard. The higher the visible light transmittance, the lower the haze value is, which indicates a better transparency for the surface coating 12.

Several examples of the aqueous surface coating solution composition of the present disclosure are listed in Table 1. However, the present disclosure is not limited to the above-mentioned examples.

TABLE 1

| | | Examples | | | | | | | | | | | | Comparative examples | | | | | |
|---|---|---|---|---|---|---|---|---|---|---|---|---|---|---|---|---|---|---|---|
| Items | | 1 | | 2 | | 3 | | 4 | | 5 | | 6 | | 1 | | 2 | | 3 | |
| Mixed | Polyester resin | 1 | | 2.75 | | 4 | | 5.45 | | 5.5 | | 1 | | 8.5 | | 1.5 | | | |
| resin | Acrylate-grafted | 7.5 | | 5.5 | | 4 | | 2.8 | | 2.2 | | 6 | | — | | — | | 8.5 | |
| | polyurethane resin | | | | | | | | | | | | | | | | | | |
| | Acrylate resin | — | | — | | — | | — | | — | | — | | — | | 5 | | | |
| Cross- | Melamine resin | 1 | | 0.4 | | 1 | | 0.5 | | 1 | | 0 | | 1 | | 1 | | | |
| linking | Oxazoline resin | — | | 1 | | 0.5 | | 0.5 | | 0.7 | | 2.5 | | — | | — | | 1 | |
| agent | | | | | | | | | | | | | | | | | | | |
| Solvent | Water | 81.97 | | 81.84 | | 82.04 | | 82.48 | | 81.89 | | 81.99 | | 83.59 | | 84.99 | | 83.59 | |
| Treatment | Anionic surfactant A | 0.05 | | 0.5 | | 0.25 | | 0.25 | | 0.05 | | 0.05 | | — | | — | | — | |
| agent | Nonionic surfactant B | 0.5 | | 0.05 | | 0.25 | | 0.25 | | 0.5 | | 0.5 | | — | | — | | — | |
| | Silicon-containing | 0.05 | | 0.05 | | 0.05 | | 0.01 | | 0.05 | | 0.05 | | — | | — | | — | |
| | compound | | | | | | | | | | | | | | | | | | |
| | Macromolecule | 1.1 | | 1 | | 1 | | 1 | | 1 | | 1 | | — | | — | | — | |
| | polymer | | | | | | | | | | | | | | | | | | |
| Filling | Particle A (particle | 0.1 | | 0.05 | | 0.15 | | 0.1 | | 0.1 | | 0.1 | | 0.2 | | — | | — | |
| particles | size 120 nm) | | | | | | | | | | | | | | | | | | |
| | Particle B (particle | 0.22 | | 0.35 | | 0.25 | | 0.15 | | 0.5 | | 0.3 | | — | | 0.5 | | — | |
| | size 50 nm) | | | | | | | | | | | | | | | | | | |
| | Particle C (particle | — | | — | | — | | — | | — | | — | | 0.2 | | — | | 0.1 | |
| | size 120 nm) | | | | | | | | | | | | | | | | | | |
| | Particle D (particle | — | | — | | — | | — | | — | | — | | — | | 0.5 | | 0.3 | |
| | size 50 nm) | | | | | | | | | | | | | | | | | | |
| Additive | Catalyst | 0.1 | | 0.1 | | 0.1 | | 0.1 | | 0.1 | | 0.1 | | 0.1 | | 0.1 | | 0.1 | |
| | Isopropanol | 5 | | 5 | | 5 | | 5 | | 5 | | 5 | | 5 | | 5 | | 5 | |
| | Butyl cellulose | 1.4 | | 1.4 | | 1.4 | | 1.4 | | 1.4 | | 1.4 | | 1.4 | | 1.4 | | 1.4 | |
| | Silicon or fluorine | 0.01 | | 0.01 | | 0.01 | | 0.01 | | 0.01 | | 0.01 | | 0.01 | | 0.01 | | 0.01 | |
| | additives | | | | | | | | | | | | | | | | | | |
| Physical | Thickness of PET | 12 | μm | 50 | μm | 50 | μm | 125 | μm | 300 | μm | 50 | μm | 50 | μm | 50 | μm | 50 | μm |
| properties | film | | | | | | | | | | | | | | | | | | |
| comparison | Surface coating | Single- | | Single- | | Single- | | Single- | | Single- | | Double- | | Single- | | Single- | | Single- | |
| items | | sided | | sided | | sided | | sided | | sided | | sided | | sided | | sided | | sided | |
| | Thickness of surface | 50 | nm | 50 | nm | 60 | nm | 80 | nm | 120 | nm | 50 | nm | 50 | nm | 50 | nm | 50 | nm |
| | coating | | | | | | | | | | | | | | | | | | |
| | Roughness Ra (A side) | 0.015 | | 0.008 | | 0.010 | | 0.011 | | 0.06 | | 0.008 | | 0.041 | | 0.028 | | 0.035 | |
| | Roughness Ra (B side) | — | | — | | — | | — | | — | | 0.008 | | — | | — | | — | |
| | Light transmittance | 91.20% | | 90.80% | | 91.10% | | 91.40% | | 91.20% | | 92.80% | | 90.11% | | 90.21% | | 90.25% | |
| | Haze value | 0.38% | | 0.42% | | 0.64% | | 0.62% | | 0.70% | | 0.78% | | 1.02% | | 0.98% | | 1.21% | |
| | Adhesion to optical glue | Good | | Good | | Good | | Good | | Good | | Good | | poor | | poor | | poor | |
| | Adhesion to optical | Good | | Good | | Good | | Good | | Good | | Good | | poor | | poor | | poor | |
| | adhesive after UV | | | | | | | | | | | | | | | | | | |
| | light irradiation | | | | | | | | | | | | | | | | | | |
| | Boil-resistant adhesion | Good | | Good | | Good | | Good | | Good | | Good | | poor | | poor | | poor | |
| | (90° C.*30 minutes) | | | | | | | | | | | | | | | | | | |
| | Dispersibility of filling | Good | | Good | | Good | | Good | | Good | | Good | | poor | | poor | | poor | |
| | particles in the surface | | | | | | | | | | | | | | | | | | |
| | coating | | | | | | | | | | | | | | | | | | |
| | Anti-sticking | 90° | C. | 90° | C. | 100° | C. | 90° | C. | 120° | C. | 90° | C. | 80° | C. | 80° | C. | 80° | C. |
| | temperature | | | | | | | | | | | | | | | | | | |

### Advantages of Embodiments

One of the advantages of the present disclosure is that the aqueous surface coating solution composition can provide the characteristics required for polyester film applications, such as high transparency, low haze value, good adhesion, and smooth texture, by virture of “the first inorganic filling particles have a larger average particle diameter than the second inorganic filling particles” and “the first inorganic filling particles and the second inorganic filling particles are uniformly dispersed in the surface coating, so that the surface coating has a surface roughness Ra between 0.004 μm and 0.025 μm”.

Furthermore, the surface coating formed by the surface coating solution composition of the present disclosure on the surface of the polyester film has stable and good releasability, so that the polyester film can be easily pulled out after being rolled and be used without any damage to the surface. In addition, the polyester film also has good adhesion, that is, has good adhesion quality with a target object (such as optical glue), and can adapt to complex three-dimensional shapes.

Moreover, the surfaces of the first inorganic filling particles and the second inorganic filling particles are modified with the epoxy-functional silane coupling agent, so as to further improve the dispersibility in the surface coating.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An aqueous surface coating solution composition, which is usable for forming a surface coating on a polyester film, wherein the aqueous surface coating solution composition comprises 5-20 wt % of a resin composition and 0.15-5 wt % of an inorganic particle dispersion liquid;
wherein the resin composition includes 0.01-10 wt % of a polyester resin, 2-19 wt % of an acrylate-grafted polyurethane resin, and 0.5-10 wt % of a cross-linking agent;
wherein the inorganic particle dispersion liquid includes a plurality of first inorganic filling particles and a plurality of second inorganic filling particles, and the first inorganic filling particles have a larger average particle diameter than the second inorganic filling particles; and
wherein the first inorganic filling particles and the second inorganic filling particles are uniformly dispersed in the surface coating, so that the surface coating has a surface roughness Ra between 0.004 μm and 0.025 μm.

2. The aqueous surface coating solution composition according to claim 1, wherein the average particle diameter of the first inorganic filling particles is between 100 nm and 180 nm, and the content of the first inorganic filling particles, based on a total weight of the surface coating, is 0.05 wt % to 1 wt %; wherein the average particle diameter of the second inorganic filling particles is between 30 nm and 80 nm, and the content of the second inorganic filling particles, based on the a total weight of the surface coating, is 0.2 wt % to 3 wt %.

3. The aqueous surface coating solution composition according to claim 2, wherein surfaces of the first inorganic filling particles and surfaces of the second inorganic filling particles are modified with an epoxy-functional silane coupling agent.

4. The aqueous surface coating solution composition according to claim 1, the first inorganic filling particles and the second inorganic filling particles are each silicon oxide, titanium oxide, zirconium oxide, aluminum oxide, aluminum hydroxide, calcium carbonate, magnesium carbonate or barium sulfate particles.

5. The aqueous surface coating solution composition according to claim 1,
wherein the cross-linking agent is selected from at least one of a melamine resin, a melamine modified resin, a carbodiimide-based cross-linking agent, and an oxazoline-based cross-linking agent.

6. A polyester film structure, comprising:
a polyester film; and
a surface coating formed on a surface of the polyester film, wherein the surface coating is formed by the aqueous surface coating solution composition according to claim 1 and has a surface roughness Ra between 0.004 μm and 0.025 μm.

7. The polyester film structure according to claim 6, wherein the average particle diameter of the first inorganic filling particles is between 100 nm and 180 nm, and the content of the first inorganic filling particles, based on the total weight of the surface coating, is 0.05 wt % to 1 wt %; wherein the average particle diameter of the second inorganic filling particles is between 30 nm and 80 nm, and the content of the second inorganic filling particles, based on the total weight of the surface coating, is 0.2 wt % to 3 wt %.

8. The polyester film structure according to claim 7, wherein surfaces of the first inorganic filling particles and surfaces of the second inorganic filling particles are modified with an epoxy-functional silane coupling agent, which is selected from at least one of 2-(3 4-epoxycyclohexyl)ethyltrimethoxysilane, (3-glycidoxypropyl)trimethoxysilane, (3-glycidoxypropyl)methyldiethoxysilane, and 3-glycidoxypropyl triethoxysilane.

9. The polyester film structure according to claim 8, wherein a visible light transmittance of the surface coating measured according to JIS K7705 test standard is at least 90%, and a haze value is less than 0.8%.

10. The polyester film structure according to claim 6, wherein a thickness of the polyester film is between 12 μm and 300 μm, and a thickness of the surface coating is between 30 nm and 150 nm.
